(19) United States
(12) Patent Application Publication
(10) Pub. No.: US 2024/0305116 A1
(43) Pub. Date: Sep. 12, 2024

(54) POWER CHARGING APPARTUS FOR GUM OR TISSUE NUMBING DEVICE(S)

(71) Applicant: Natasha, LLC, Burbank, CA (US)

(72) Inventors: Ara Gulesserian, Glendale, CA (US); Alen Simon, Burbank, CA (US)

(21) Appl. No.: 18/437,204

(22) Filed: Feb. 8, 2024

Related U.S. Application Data
(60) Provisional application No. 63/444,271, filed on Feb. 9, 2023.

(51) Int. Cl. H02J 7/00; A61C 19/08; H02J 7/34; H02J 50/10

(52) U.S. Cl. CPC H02J 7/0044; A61C 19/08; H02J 7/0013; H02J 7/345; H02J 50/10; H02J 2207/30

(57) ABSTRACT

A power charging assembly includes two or more gum or tissue numbing devices, the two or more gum or tissue numbing devices including a power charging interface and one or more rechargeable batteries; a base assembly; one or more power electronics printed circuit boards (PCBs) to generate electrical power, the one or more power electronics PCBs including two or more charging interfaces, the two or more charging interfaces to connect to the associated power charging interface of the two or more gum or tissue numbing devices; and a power interface port, the power interface port configured to accept a power cable coupled to an external power source, the external power source to provide power to the power charging assembly through the power interface port.

### RELATED APPLICATIONS

This application claims priority to U.S. provisional patent application Ser. No. 63/444,271, filed Feb. 9, 2023, entitled “Gum and Tissue Numbing Device,” the disclosure of which is hereby incorporated by reference.

### BACKGROUND

The application of Novocain or other numbing agents to dental patients may be a painful procedure. Many dentists utilize a local numbing agent to numb the area where the Novocain shot may be administered. However, this application does not work in many cases because the local numbing agent does not work immediately, the local numbing agent may be applied to the wrong area because a nurse or hygienist is not familiar with where the dental work will be performed and/or the taste of the numbing agent may be transferred to the patient's throat due to saliva.

Accordingly, the Novocain shot may be painful and may take longer due to the discomfort felt by the patient. Tools have been developed to address this problem where a large device applies a vibration to the area where the Novocain shot will be delivered. However, the dentist is not able to pinpoint the large vibrating device with the greatest precision to the correct area because the vibration device is too large and is not flexible.

Therefore, a need exists for a numbing device that is flexible, small and able to numb an area where a needle will be inserted into a patient's tissue area (e.g., a gum area).

### BRIEF DESCRIPTION OF DRAWINGS

FIG. 1 illustrates wireless gum or tissue numbing devices according to some embodiments;

FIG. 2A illustrates a wireless gum or tissue numbing device inserted on a professional's finger according to some embodiments;

FIG. 2B illustrates an exploded view of the wireless gum or tissue numbing device according to some embodiments;

FIG. 3 illustrates an additional embodiment of the wireless gum or tissue numbing device according to some embodiments;

FIG. 4 illustrates an exploded view of an additional embodiment of the wireless gum or tissue numbing device according to some embodiments;

FIG. 5 illustrates a control assembly for one or more wireless gum and tissue numbing devices according to some embodiments;

FIG. 6A illustrates a gum or tissue numbing device and an associated sleeve according to some embodiments;

FIG. 6B illustrates a side view of a gum or tissue numbing device case and a perspective view of the gum or tissue numbing device case according to some embodiments;

FIG. 6C illustrates a gum or tissue numbing device attached or coupled to a user or doctor's finger according to some embodiments;

FIG. 6D illustrates separate drawings of a gum or tissue numbing device and a numbing device sleeve and also illustrates a gum or tissue numbing device being inserted into the slot or opening of the numbing device sleeve according to some embodiments;

FIG. 6E illustrates a bottom perspective exploded view of a single gum or tissue numbing device according to some embodiments;

FIG. 6F illustrates a combined sleeve and gum or tissue numbing device according to some embodiments;

FIG. 6G illustrates a separated sleeve and gum or tissue numbing device according to some embodiments;

FIGS. 7A illustrates an exploded view of a gum or tissue numbing device power charging assembly for multiple gum or tissue numbing devices according to some embodiments;

FIG. 7B illustrates a power charging assembly base according to some embodiments; and

FIG. 8 is a block diagram of a heating and cooling system for the molded soft rubber portion or the sleeves of the gum numbing devices according to exemplary embodiments.

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

Accordingly, a device is needed that may be flexible and/or may reach into small spaces. In some embodiments, a wireless gum or tissue numbing device may be placed and/or positioned onto a finger or fingertip of a medical professional so that the medical professional can easily apply it to any areas of the patient's gum and/or tissue. In some embodiments, a medical professional can utilize two wireless gum or tissue numbing devices in order to isolate a specific area of a patient's gum or tissue in between the gum or tissue numbing devices. This is especially useful for dentists.

Although this description focuses on Novocain, the techniques and devices described herein may be utilized with the application of botox through needles or other substances through needles.

Although the above and below paragraphs describe a dental procedure, the device described below may be utilized with other patient tissue areas where patients will be receiving shots and/or having needles inserted. For example, the apparatus and/or methods described above is also applicable to other professionals (e.g., medical or cosmetic) that inject medications or liquids (e.g., botox or lidocaine) into a patient's or individual's tissue. The numbing device described below has equal application to these other uses also.

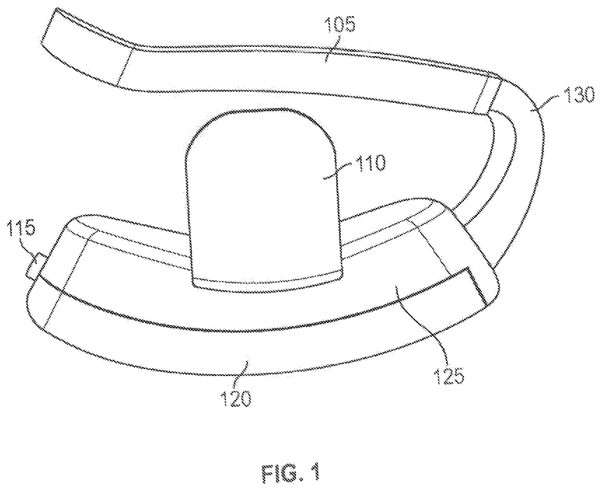

FIG. 1 illustrates wireless gum or tissue numbing devices according to some embodiments. In some embodiments, a wireless gum or tissue numbing device 100 may include a finger holding clip 105, a fingertip retention piece 130, a base plate piece 125, an over molded soft rubber cover assembly 120, one or more lateral finger support flaps or plates 110, and/or an on/off switch 115. The small footprint of the wireless gum or tissue numbing device allows a medical professional to utilize these devices in smaller areas than prior art devices have been utilized in. Most other devices are large devices that are utilized on larger or big areas of a patient, and thus cannot pinpoint an area in the mouth where a needle will be inserted into a patient's gum or a patient's tissue. The wireless gum or tissue numbing device may be placed on medical professional's fingers and thus take up less space. Because the device is placed on the medical professional's fingers, the device may easily be inserted inside a patient's mouth. In addition, because the wireless gum or tissue numbing device is positioned on a medical professional's fingers, the medical professional can localize and/or pinpoint where the numbing is applied and this provides the medical professional with a large amount of flexibility in administering the numbing injection.

In some embodiments, the finger holding clip 105 may be placed or positioned on a top of a medical professional's fingers. In some embodiments, a bottom surface of the finger holding clip 105 may touch or contact a top surface of the medical professional's fingers. In some embodiments, the finger holding clip 105 may range from 1.0 inches and 1.25 inches in length, or alternatively may range from 0.75 inches and 1.5 inches in length. In some embodiments, the finger holding clip 105 may range from 0.5 inches and 0.75 inches in width, or alternatively range from 0.3 and 0.9 inches in width. In some embodiments, the finger holding clip 105 may have a height ranging from 0.05 and 0.15 inches in height, or alternatively range from 0.025 and 0.0175 inches in height. In some embodiments, the finger holding clip 105 should have a small height to minimize an overall height footprint of the wireless gum or tissue numbing device 100. This small footprint allows the wireless gum or tissue numbing device to be utilized and/or applied in smaller spaces like a patient's mouth, although the claimed subject matter is not limited to this application. In some embodiments, a first end of the finger holding clip 105 is curved up or raised up with respect to a remainder of the body of the finger holding clip 105. In some embodiments, the second end of the finger holding clip 105 may be coupled to the fingertip retention piece 130. In some embodiments, the finger holding clip 105 may be made of a plastic or composite material, although other materials may be utilized.

In some embodiments, the fingertip retention piece 130 may be coupled to the finger holding clip 105 and may also be coupled to the base plate piece or assembly 125. In some embodiments, the fingertip retention piece 130 may be attached, coupled, connected to and/or inserted into a second end of the finger holding clip 105. In some embodiments, the fingertip retention piece 130 may be attached, coupled, connected and/or inserted into a second end of a base plate piece or assembly 125. In some embodiments, fingertip retention piece 130 may be positioned vertically between the finger holding clip 105 and the base place piece or assembly 125. In some embodiments, the fingertip retention piece 130 may be curved in shape to allow for the fingertip to be inserted (it follows the shape of the fingertip and has a longer opening on the portion of the fingertip retention piece 130 that is near the finger holding clip 105).

In some embodiments, the fingertip retention clip 105 may be made of a plastic material and/or a composite material. In some embodiments, the fingertip retention clip may have a height ranging from 0.5 inches to 0.8 inches, or alternatively from 0.3 inches to 0.9 inches. In some embodiments, the fingertip retention clip 130 may have a width of 0.1 inches to 0.2 inches, or alternatively 0.05 inches to 0.25 inches.

In some embodiments, a second end of base plate piece or assembly 125 may be connected, attached, coupled and/or receive the fingertip retention piece 130. In some embodiments, an on/off switch and/or activation switch 115 may be connected, attached or coupled to, and/or embedded in a second end of the base place piece or assembly 125. In some embodiments, one or more lateral finger support flaps 110 may be connected, attached, coupled and/or inserted into the base plate piece or assembly 125. In the embodiment illustrated in FIG. 1, there are two lateral finger support flaps or support assemblies 110 that the medical professional's fingers may be inserted in between. In some embodiments, the one or more lateral finger support flaps or assemblies 110 may be connected, attached, or coupled to and/or inserted into opposite sides of the base plate piece or assembly 125. In some embodiments, the one or more lateral finger support flaps or assemblies 110 may have a curved shape where one end of the one or more lateral finger support flaps or assemblies 110 is inserted, coupled or attached to the base plate 125 and then the remainder of the one or more lateral finger support flaps or assemblies 110 is curved between 60 to 120 degrees so that the remainder and/or other end of the one or more lateral support flaps or assemblies 110 rise vertically from the sides of the base plate piece or assembly 125. In some embodiments, the one or more lateral finger support flaps or assemblies 110 are made of a plastic and/or composite material. In some embodiments, the medical professional may place their index finger and/or thumb in between the one or more lateral finger support flaps or assemblies 110. In some embodiments, the lateral finger support flaps or assemblies 110 may have a height range of 0.4 inches to 0.75 inches, or alternatively have a height range of 0.3 inches to 0.9 inches. In some embodiments, the lateral finger support flaps or assemblies 110 may have a width range of 0.3 inches to 0.5 inches, or alternatively may have a width range of 0.2 inches to 0.7 inches.

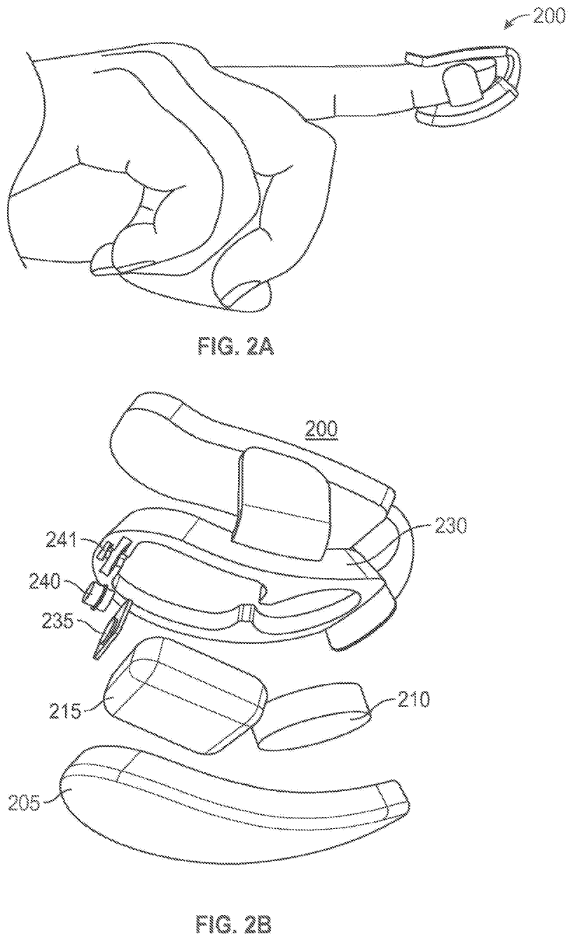

In some embodiments, the base plate piece or assembly 125 may have a shape that is curved upwards at both ends of the base plate piece or assembly 125. In some embodiments, by having a curved upward shape, the medical professional may always be able to apply or press as much of a bottom surface of the base plate piece or assembly 125 on the gum or tissue of the patient or user and thus have a device that provides the best performance (in terms of a surface area to be numbed). In some embodiments, the upwardly curved top surface of the base plate piece or assembly 125 mimics or approximates the shape of a bottom side of a medical professional's finger and/or fingertip. In some embodiments, the base plate piece or assembly 125 has a bottom side or underside where components may be located that are utilized to power and/or operate the wireless gum or tissue numbing device 100. As will be discussed with respect to FIGS. 2A and 2B, the bottom side of the base plate piece or assembly 125 includes one or more cavities for different components of the wireless gum numbing or tissue device. In some embodiments, the base plate piece or assembly 125 may have a ledge or lip or wall on the second end on its bottom side. In some embodiments, the base plate piece or assembly 125 may be made of a composite material and/or a plastic material. In some embodiments, an over molded soft rubber covering may cover a bottom surface of the base plate piece or assembly 125. In some embodiments, the over molded soft rubber covering 120 may hold the components in the openings or cavities of the base plate piece or assembly 125 and/or also protect these components. The over molded soft rubber covering 120 may be pressed against or in contact with an inside surface of the lip or ledge of the bottom side of the base plate piece or assembly 125. In some embodiments, the over molded covering 120 is made of rubber because it comes in contact with a patient's mouth, gums and/or tissue, and thus cannot be rough or abrasive. In some embodiments, a base plate piece or assembly 125 may range in length from 1.05 inches to 1.45 inches, or alternatively from 0.80 to 1.6 inches. In some embodiments, a base plate piece or assembly 125 may range in height from 0.1 to 0.2 inches or from 0.05 inches to 0.3 inches. In some embodiments, a base plate piece or assembly 125 may have a width ranging from 0.58 to 0.85 inches, or alternatively from 0.50 to 0.95 inches. In some embodiments, the over molded soft rubber covering 120 may have a length slightly less that the base plate piece or assembly 125, may have a height that is less than the based plate piece or assembly 125, and/or a similar width to the base plate piece or assembly 125.

FIG. 2A illustrates a wireless gum or tissue numbing device inserted on a professional's finger according to some embodiments. FIG. 2B illustrates an exploded view of the wireless gum or tissue numbing device according to some embodiments. FIG. 2A illustrates how the wireless gum or tissue numbing device fits onto a finger of the professional, in this case the index finger (although other fingers may be utilized). In some embodiments, the wireless gum or tissue numbing device 200 may comprise an ABS Plastic base plate piece or assembly 230 (which could be made from other materials), an on/off switch cover 240, an on-off switch assembly 241, a printed circuit board including an on-off switch along with control electronics 235, a rechargeable power source 215, a soft rubber cover 205, and/or a vibration motor assembly 210. In some embodiments, the wireless gum or tissue numbing device 200 may vibrate at specific frequencies when activated (e.g., turned on or turned off). In some embodiments, the base plate piece or assembly 230 may comprise cavities that receive the different components. In some embodiments, moving from a first end of the base plate piece or assembly to the second end, the base plate piece or assembly 230 may comprise a first cavity for the on-off switch cover 240, a second cavity for the printed circuit board 235, a third cavity for the rechargeable battery 215 and/or a fourth cavity for the vibration motor assembly 210. In some embodiments, other components or circuit boards may be utilized such as wireless transceiver chipsets, communication circuit boards, control circuit boards or chipsets for controlling operations for vibration motor assemblies 210 or other components. In these embodiments, the base plate piece or assembly 230 may include additional cavities or openings and/or differently shaped openings or cavities in a bottom surface of the base plate piece of assembly 230.

In some embodiments, the soft rubber cover 205 may be placed, attached, connected and/or coupled to the bottom of the base plate piece or assembly 230 to cover the components of the wireless gum or tissue numbing device, such as the PCB with control electronics 235, on-off switch 241, the rechargeable battery 215, and/or the vibration motor 210. In some embodiments, the rechargeable battery may be a lithium battery or a lithium polymer battery. In some embodiments, the rechargeable battery 215 may be a 3.7 volt, 30 milliamp lithium battery. In some embodiments, the rechargeable battery may be square, rectangular and/or oval in shape. In some embodiments, the sides of the rechargeable battery may be less than 0.75 inches in length. In some embodiments, the sides of the rechargeable battery may alternatively be less than 0.64 inches in length. In some embodiments, other batteries may be utilized. In some embodiments, the rechargeable battery may have dimensions of 0.4 inch by 0.4 inch.

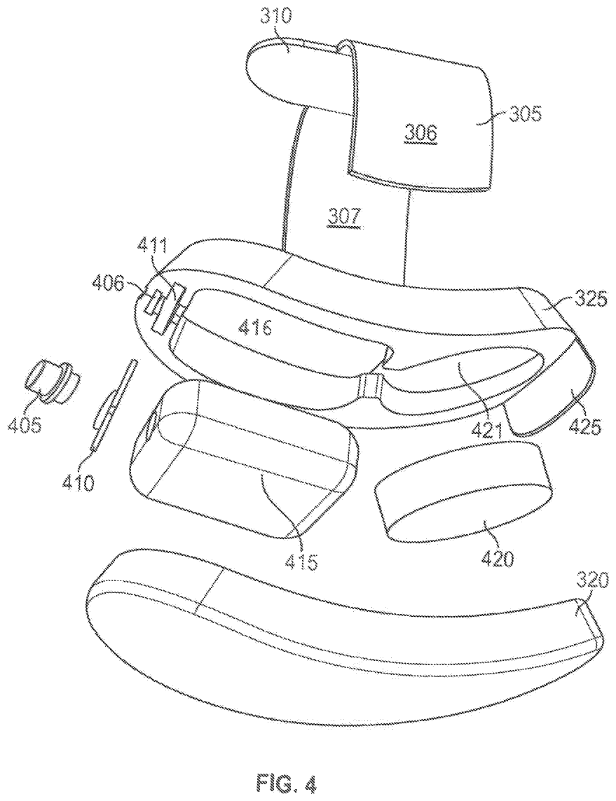

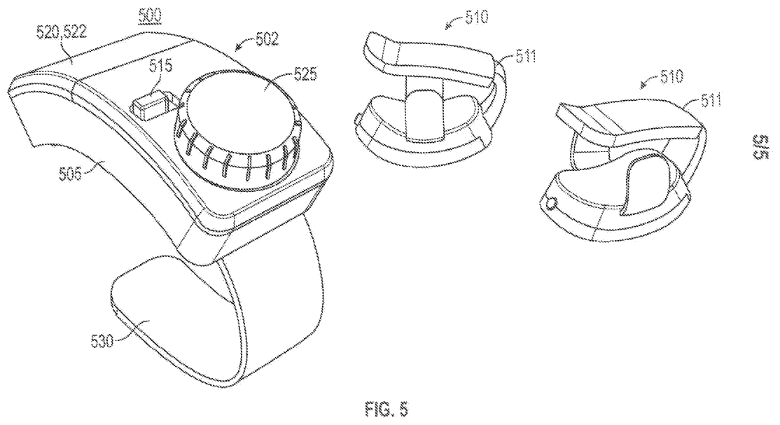

In some embodiments, the vibration motor may be a 3 Volt coin motor. In some embodiments, the vibration motor may be circular, square or oval in shape. In some embodiments, the vibration motor 210 may rotate at 12,000 revolutions per minute, or alternatively between 8,000 to 16,000 revolutions per minute. In some embodiments, the vibration motor 210 may be less than 0.75 inches in diameter, or alternatively less than 0.65 inches in diameter. In some embodiments, the vibration motor may be 0.4 inches in diameter. In some embodiments, the vibration motor 210 may have a low setting corresponding to 8,000 revolutions per minute; a medium setting corresponding to 10,000 revolutions per minute; and a high setting corresponding to 12,000 revolutions per minute. In some embodiments, a vibration motor assembly may have a maximum revolution per minutes (rpm) of 16,000 rpm, which may change the low, medium and high rpm settings. In some embodiments, the vibration motor assembly 210 may include a controller and/or control electronics and in other embodiments, the controller or control electronics may be located externally or apart from the coin motor. This is also true with respect to the wireless gum or tissue numbing device described below with respect to FIGS. 4 and 5. In some implementations, for example, the number of revolutions per minute for the vibration and/or motor assembly may range from 2,000 to 12,000 revolutions per minute. In some implementations, a voltage supplied to a motor controller and/or the vibration or motor assembly may be a voltage or voltage value and generate the number of revolutions per minute for the vibration/motor assembly based at least in part on the received voltage value or voltage. As an example, the received voltage value may be range from 1.0 to 5.0 volts and different voltage values may correspond to different revolutions per minute (e.g., 1.5 volts may correspond to 3,000 revolutions per minute, 2.5 volts may correspond to 6,000 revolutions per minute and 4 volts may correspond to 9,000 revolutions per minute). In some embodiments, no controller or control electronics may need to be utilized.

In addition to the wireless gum or tissue numbing device utilizing vibration to numb a patient's gum or tissue, the wireless gum or numbing device 200 may also utilize cold to numb a patient's gum or tissue. In some embodiments, the wireless gum or tissue numbing device 200 may utilize a cold surface in order to assist in numbing the tissue and/or gum. In some embodiments, the entire wireless gum or tissue numbing device 100 may be placed in a refrigerator in order to lower the temperature of the soft rubber cover 205 and assist in the numbing of the patient gum or tissue. In some alternative embodiments, the soft rubber cover 205 may be placed into a refrigerator or freezer in order to lower the temperature of the rubber cover 205 and also provide additional comfort to the patient. In these embodiments, the soft rubber cover 205 may be removed from the refrigerator and/or freezer, placed onto the wireless gum or tissue numbing device, and then positioned on the medical professional's finger.

In some embodiments, heat may be utilized to assist the medical professional in comforting the patient. In some embodiments, the whole wireless gum or tissue numbing device 200 cannot be placed into a microwave or oven without damaging the device and/or oven or microwave. In some embodiments, the soft rubber cover 205 may be placed into an oven or a slow heating device in order to heat up the cover.

However, care must be taken to make sure the soft rubber cover 205 does not get too hot because that may damage a patient's gum or tissue. In some embodiments, a soft rubber cover 215 may also be made of ABS plastic with a secondary operation to cover it with soft rubber. After the software rubber cover 205 is heated, the cover 205 may be placed onto the wireless gum or tissue numbing device and provide additional comfort to the patient.

In some embodiments, the wireless gum or tissue numbing device 200 may be disposable after a single use or after a couple of uses. In some embodiments, if the wireless gum or tissue numbing device 200 is disposable, the software rubber cover 205 may not be removable. In such an embodiment, the wireless gum or tissue numbing device 200 may be sealed and/or may be water resistant.

In some embodiments, the rechargeable battery 215 may be utilized for two or three patients before needing to be recharged again. In some embodiments, the rechargeable battery 215 may be utilized for ten, twenty, fifty or a hundred patients or individuals. In some embodiments, the wireless gum or tissue numbing device may have a port that connects to the rechargeable battery 215 to allow an external power source to recharge the battery 215. In addition, there may be a pod device or plate device external to the gum or tissue numbing device where the rechargeable battery may be charged. In these embodiments, the battery 215 may be recharged via wireless charging or induction charging. In some embodiments, the rechargeable battery 215 may have a lifespan of 300 to 500 charge cycles and/or alternatively two to three years. In some embodiments, medical professionals may include have a number of rechargeable batteries on hand to be able to replace in case the rechargeable battery in the wireless gum or tissue numbing device loses its charge.

In some embodiments, in order to sterilize the wireless gum or tissue numbing device and/or the soft rubber cover 205, the wireless gum or tissue numbing device 200 and/or the soft rubber cover 205 may be exposed to ultraviolet light in order to kill bacteria and/or particles from the patient that may be present. This allows the wireless gum or tissue numbing device and/or the soft rubber cover 205 to be utilized multiple times. In other embodiments, a disinfecting spray may be utilized to sterilize the wireless gum or tissue numbing device and/or the soft rubber cover 205.

In some embodiments, a disposable soft rubber or a cloth cover may be utilized to protect the device from patient exposure or contamination. In such an embodiment, a wireless gum or tissue device may be reusable with the rubber covers being disposable. In some embodiments, this means that one or more soft rubber or cloth covers may also cover the entire assembly. In some embodiments, a latex, nitrate, or other protective barrier material utilized in the medical or dental industry may cover the wireless gum or tissue numbing device in order to provide sterilization for the patients.

In some embodiments, the wireless gum or tissue numbing device 200 may be operated as follows. In some embodiments, the wireless gum or tissue numbing device may have one vibration speed. In such an embodiment, a user may activate the device by pressing an on-off switch. In this embodiment, when the on-off switch is activated, the switch connects or couples the battery to the motor or vibration assembly and the wireless gum or tissue numbing device may vibrate until the on-off switch is touched again.

In some embodiments, the wireless gum or tissue numbing device may have multiple vibration speeds. In some embodiments, for example, the wireless gum or tissue numbing device may have a !ow vibration speed, a medium vibration speed or a high vibration speed. In this embodiment, a user may press the push button (or on-off switch) one time and the wireless gum or tissue numbing device may enter into a low vibration mode. In this embodiment, when the push button is pressed a second time, the wireless gum or tissue numbing device may enter into a medium vibration mode. In this embodiment, if the user presses the push button a third time, the wireless gum or tissue numbing device may enter into a high vibration mode. In this embodiment, if the user presses the push button a fourth time, the wireless gum or tissue numbing device may turn off or deactivate.

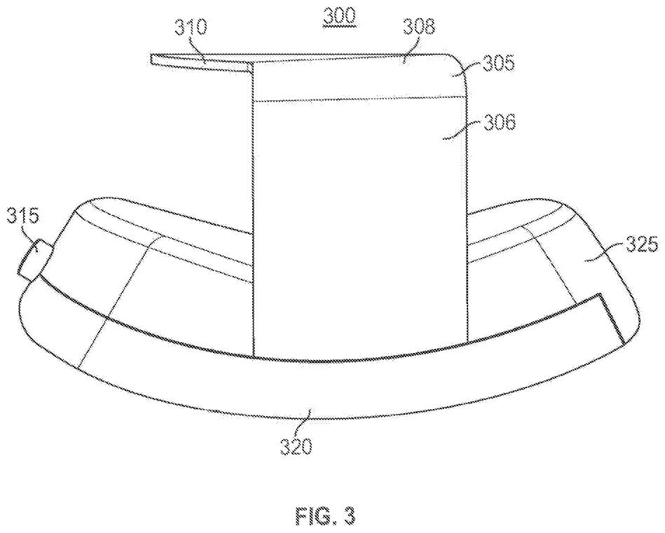

FIG. 3 illustrates an additional embodiment of the wireless gum or tissue numbing device according to some embodiments. In some embodiments, a wireless gum or tissue numbing device 300 may comprise a base assembly 325, an on/off switch 315, a soft rubber cover 320, a pulling or grip tab 310 and/or a finger retainer assembly 305. In some embodiments, the base assembly 325, the soft rubber cover 320 and/or the on/off switch 315 may operate as described above with the wireless gum or tissue numbing device described above with respect to FIGS. 1 and 2. In some embodiments, a finger retainer assembly 305 may have a semicircular shape or may be shaped like an arch. In some embodiments, a finger retainer assembly 305 may have two sides (side 306 is shown in FIG. 3 and both sides 306 and 307) and a top portion 308. In some embodiments, the first side 306 of the finger retainer assembly 305 and a second side 307 of the retainer assembly 305 may be attached, coupled, connected and/or attached into a corresponding first side and corresponding second side of the base assembly 325. In some embodiments, the first side 306 and the second side 307 of the retainer assembly may be connected, attached, coupled or inserted into corresponding sides of the base assembly 325 at a junction wherein the soft rubber cover 320 attaches to the base assembly 325. In some embodiments, the first side 306 and the second side 307 of the finger retainer assembly 305 rise above or and/or positioned vertically with respect to the base assembly 325 and are connected to the top portion 308 of the finger retainer assembly 308. In some embodiments, the top portion 308 of the finger retainer assembly may be slightly curved and then may be positioned or run in a horizontal direction across a top of a medical professional's finger. In some embodiments, a pulling or gripping tab 310 may allow easy positioning or removal of the wireless gum or tissue numbing device 300 on a medical professional's finger. In some embodiments, a pulsing or gripping tab 310 may have a semicircular shape.

In some embodiments, the pulling tab 310 may be connected and/or attached to a side of a top portion 308 of the finger retention assembly. In some embodiments, the first side 306, the second side 307 and the top portion 308 of the finger retainer assembly 305 are formed as one piece. In some embodiments, the first side 306, the second side 307, the top portion 308, and the pulling tab 310 of the finger retainer assembly 305 are formed as one piece. In some embodiments, the finger retainer assembly 305 is made of a soft rubber material so as to not irritate a patient's mouth or tissue as well as to not irritate or rub against a medical professional's finger. In some embodiments, the finger retainer assembly 305 may have a height of 0.5 inches, or alternatively may have a height in a range of 0.3 inches to 0.7 inches. In some embodiments, the finger retainer assembly 305 may have a width of 0.65 inches, or alternatively may have a range of width of 0.4 to 0.8 inches. In some embodiments, the finger retainer assembly 305 may be a depth from front to back of 0.35 inches, or alternatively may have a depth range of 0.2 to 0.5 inches. In some embodiments, the top portion 308 and the pulling tab 310 of the finger retaining assembly 305 may have a depth of front to back of 0.55 inches, or alternatively a depth range of 0.4 inches to 0.7 inches.

FIG. 4 illustrates an exploded view of an additional embodiment of the wireless gum or tissue numbing device according to some embodiments. In some embodiments, the wireless gum or tissue numbing device 400 may include the finger retaining assembly 305 and/or the base assembly 325. In some embodiments, the base assembly may include a bottom vertical plate 425 that is at a second end of the base assembly 325. In some embodiments, the bottom vertical plate 425 may be utilized to retain the soft cover assembly 320 at one end. In some embodiments, the bottom vertical plate 425 may be connected and/or attached to a bottom surface of the base assembly 325. In some embodiments, the bottom vertical plate 425 and the base assembly 325 may be formed as one piece. In some embodiments, the bottom portion of the base assembly 325 may include, from a first end to a second end, an on/off switch cavity 406, a control printed circuit board cavity 411, a rechargeable battery cavity 416, and/or a motor assembly cavity 421. In some embodiments, an on/off switch 405 may be placed and/or positioned in the on/off switch cavity 406. In some embodiments, a control PCB 410 may be placed and/or positioned in the PCB cavity 411. In some embodiments, a rechargeable battery 415 may be placed and/or positioned in a battery cavity 416. In some embodiments, the motor assembly 420 may be placed and/or positioned in the motor cavity 421. In some embodiments, the soft cover assembly 320 may hold and/or support these components (e.g., the PCB 410, the on/off switch 405, the battery 415 and/or the motor assembly 420) in their respective cavities. In some embodiments, the dimensions discussed above with respect to FIG. 2 may be the same as in the embodiment of FIG. 4. The additional components discussed above with respect to FIG. 2 may also apply to the embodiment disclosed in FIG. 4.

In some embodiments, the wireless gum or tissue numbing device could include additional features and/or functions. However, in many embodiments, these features or functions may not be utilized because the wireless gum or tissue numbing device may be disposable and/or single use and the cost of the device may be minimal. For example, the wireless gum or tissue numbing device may be voice activated by including software on the control PCB that responds to voice commands. In some embodiments, a pressure sensor and/or a piezo-electric sensor may be installed on the wireless gum or tissue numbing device may be activated in response to pressure on the sensor. In some embodiments, the wireless gum or tissue numbing device may further include a wireless communication transceiver, one or memory devices, one or more processors and/or software to receive commands from an external computing device in order to activate the wireless gum or tissue numbing device. The additional features or functions and/or electrical, mechanical or electro-mechanical components may be utilized in the embodiments described in FIGS. 2 and 4.

FIG. 5 illustrates a control assembly for one or more wireless gum and tissue numbing devices according to some embodiments. In some embodiments, a system may include a control assembly 500 and one or more wireless gum or tissue numbing device(s) 510 (there are two devices illustrated in FIG. 5). In some embodiments, the control assembly 500 may include one or more wireless communication transceivers 520 to control some or all of the operations of the one or more wireless gum and tissue numbing devices 510 that may include one or more wireless communication transceivers 511. In some embodiments, the one or more wireless communication transceivers 511 may communicate with and/or activate the one or more motor assemblies in the respective one or more gum and tissue numbing devices 510. In some embodiments, the control assembly 510 may include a connector assembly or wrist connection assembly or wristband 530 and a body 505, where the connection assembly 505 allows the body 505 to be placed on a user's wrist or arm. At one end, the connection assembly 530 may be connected, coupled or attached to the body 505. In some embodiments, the body may include a voltage regulator 525, an on/off switch 515, one or more power sources 522 and/or one or more wireless communication emitters and/or transceivers 520.

In some embodiments, the voltage and/or rpm regulator 525 may allow a user to set an rpm level for the one or more wireless gum or tissue numbing devices 510. In some embodiments, this means that a specific voltage level may be transmitted or communicated to the one or more gum or tissue numbing devices 510 via the one or more wireless communication transceivers 520. In some embodiments, the voltage and/or rpm regulator 525 may be a knob that may be moved to different settings. In some embodiments, the voltage and/or rpm regulator 525 may be a switch. In some embodiments, the voltage and/or rpm regulator 525 may include a microphone that receives voice commands and/or software that analyzes the voice command in order to determine which rpm setting the user or customer would like the one or more wireless gum or tissue numbing devices 510 to operate at. In some embodiments, the on/off switch 515 may allow a user or customer to turn on or off the control assembly 500 in order to activate the control assembly. In some embodiments, the on/off switch 515 may be a push button switch, although in alternative embodiments, the on/off witch may be a different type of switch or a knob. In alternative embodiments, the turning on and/or off of the control assembly may be voice controlled.

In some embodiments, the power source may be a battery 522. In some embodiments, the body 505 may have integrated therein a rechargeable battery and/or a replaceable battery 522. In some embodiments, the body 505 may have integrated therein a disposable battery 522. In some embodiments, the body may include a port or interface in order to recharge the battery 522. In some embodiments, the battery 522 may provide power for the on/off switch 515, the rpm or voltage regulator 525, and/or the one or more wireless communication transceivers or emitters 520. In some embodiments, the body 505 may include a one or more wireless communication transceivers or emitters integrated therein. In some embodiments, the one or more wireless communication transceivers or emitters 520 may operate according to the Bluetooth protocol, or in alternative embodiments, according to another personal area network protocol (e.g., Zigbee or others). In some embodiments, the one or more wireless communication transceivers 520 may operate according to wireless local area network communication protocols (e.g., such as WiFi or other 802.11 wireless protocols).

In some embodiments, the body 505 may include one or more controllers, one or more memory devices and/or computer-readable instructions stored in the one or more memory devices. In some embodiments, the voltage and/or rpm regulator 525 may generate a signal, command, instruction and/or message indicating a desired rpm for the motor assembly in the one or more wireless gum or tissue numbing devices. In some embodiments, the computer-readable instructions may be executable by the one or more controllers or processors and may communicate or send the generated desired rpm indication to the internal wireless communication transceiver or emitter 520, which in turn may communicate to the one or more wireless communication transceivers or receivers 511 in the one or more gum or tissue numbing devices 510. In some embodiments, this allows an operator to utilize the control assembly 500 to set operational characteristics for the one or more gum or tissue numbing devices 510 easily because the control assembly is on the operator or user's wrist. In some embodiments, the user or operator may then turn off the control assembly or device 500 and pickup the needle that may be utilized to apply the gum or tissue numbing substance to the gum or tissue. In some embodiments, the control assembly or device 500 may not need to be turned off when operating the one or more wireless gum or tissue numbing device. The user or operator may then place the one or more wireless gum or tissue numbing devices 510 in the desired area to initially numb the gum or tissue and the one or more wireless gum or tissue numbing devices may be operating at the desired rpm. In some embodiments, the signals, commands, instructions and/or messages may be communicated to the one or more wireless communication transceivers or receivers 511 in the one or more gum or tissue numbing device, which may communicate this information, parameters and/or data to the vibration or motor assembly in the one or more gum or tissue numbing device. In some cases, the vibration and/or motor assembly may include a controller to receive a message, information, parameter and/or a signal from the wireless communication transceiver or receiver 511. In some implementations, the one or more motor assemblies may be the motor assemblies or vibration assemblies described in FIGS. 2 and 4.

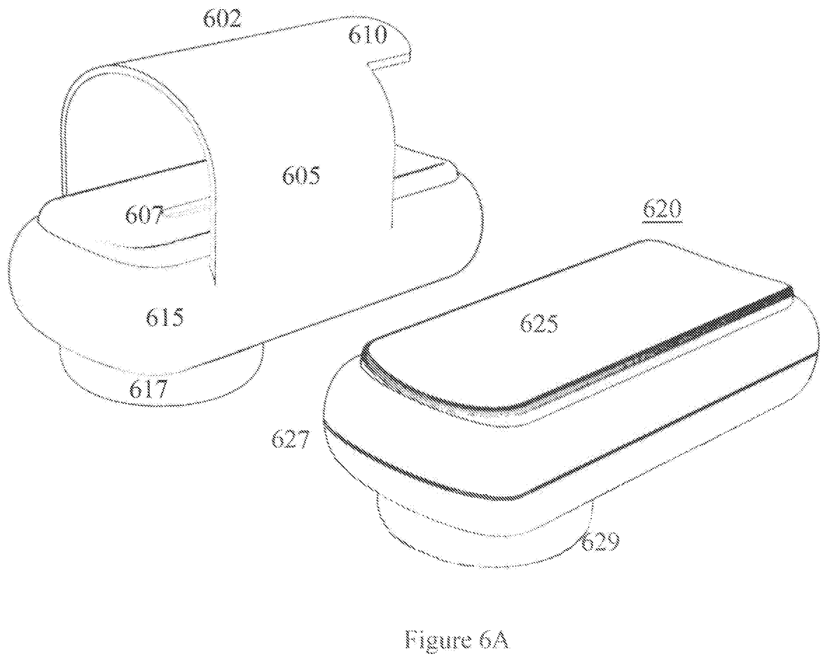

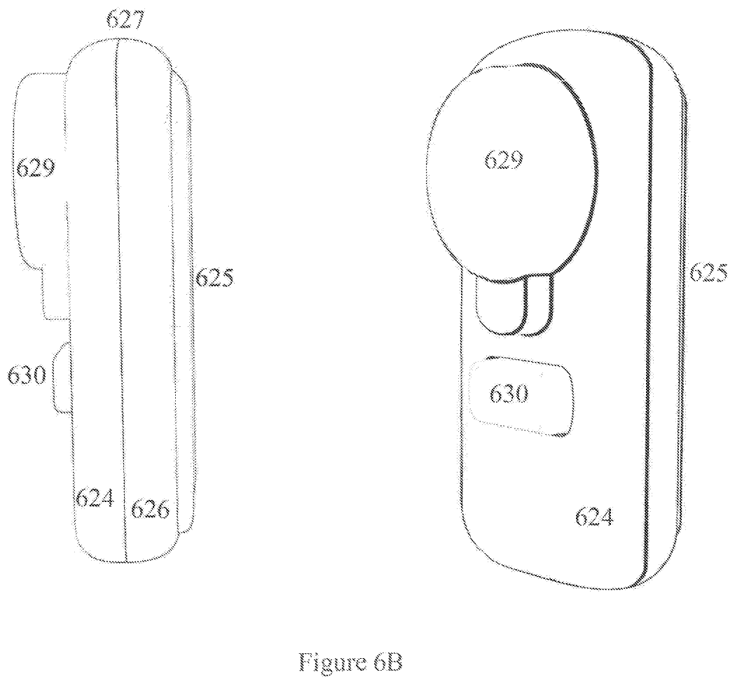

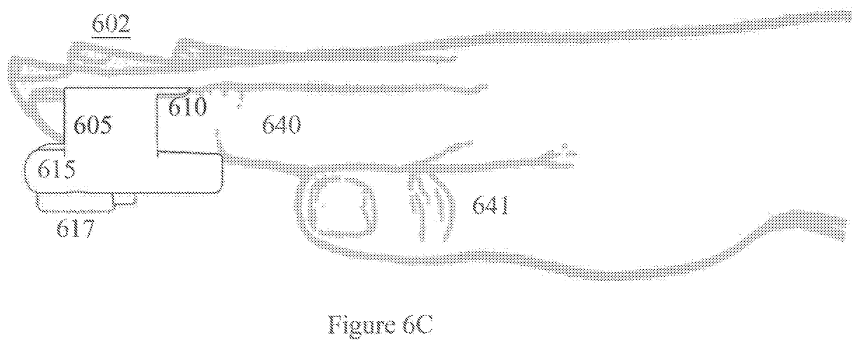

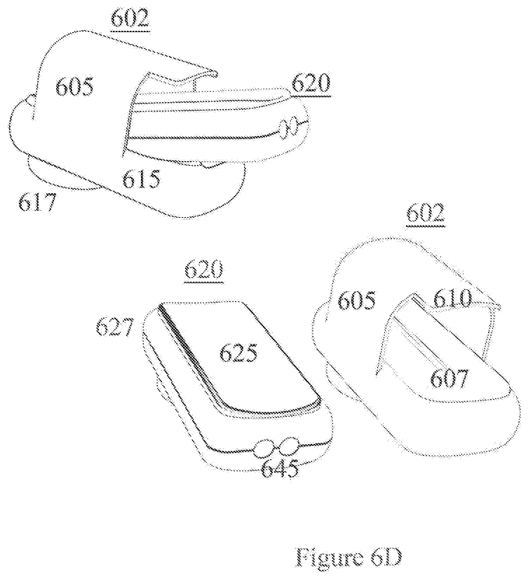

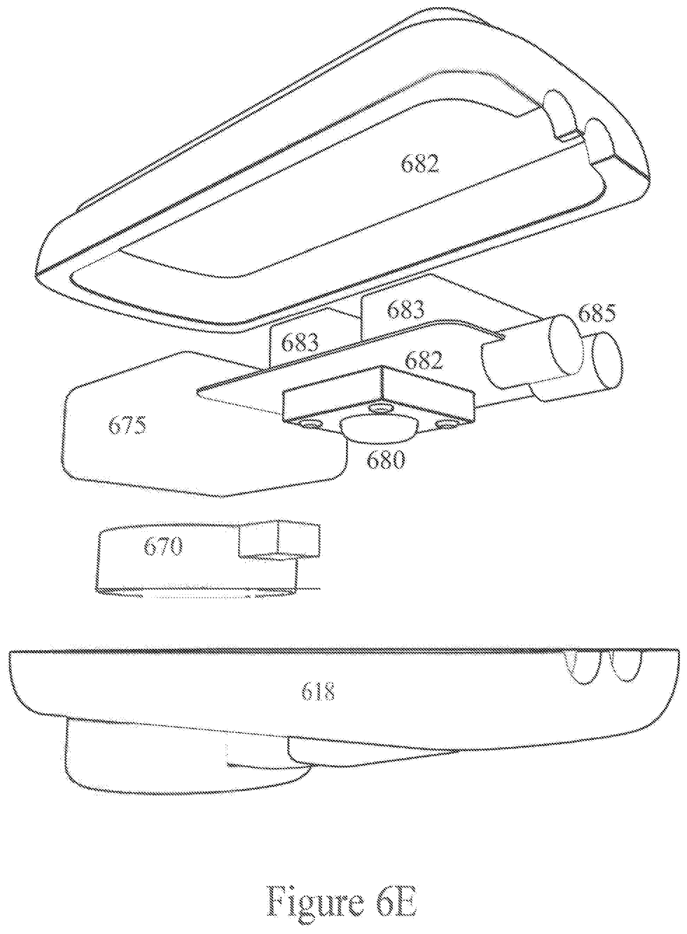

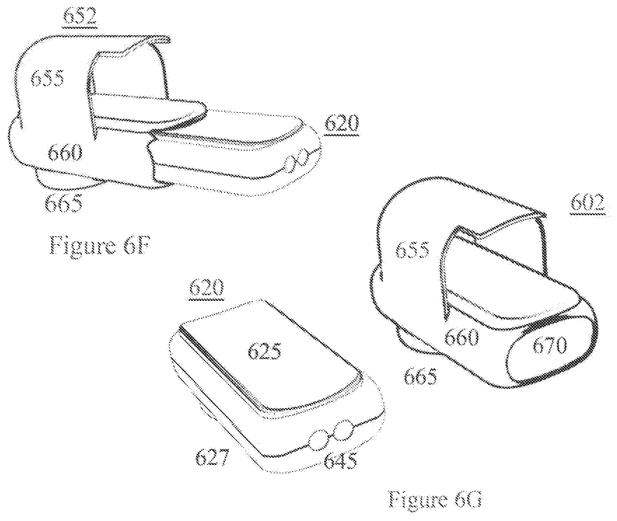

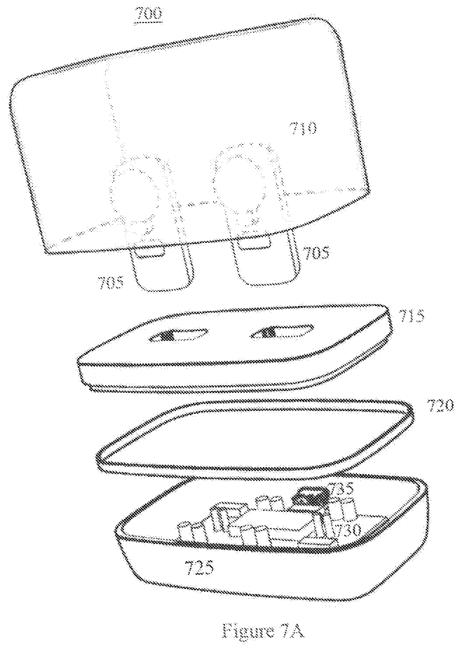

FIG. 6A illustrates a gum or tissue numbing device and an associated sleeve according to some embodiments. In some embodiments, the gum or tissue numbing device 620 may include a rubber overmold or pad 625, a gum or tissue numbing device body 627, and/or a vibrating motor assembly cover 629. In some embodiments, the gum or tissue numbing device 620 covers or body may be made of a plastic or a composite material.

In some embodiments, a sleeve 602 for the gum or tissue numbing device 620 may be a sterile latex sleeve in order to not introduce disease or bacteria into a patient's mouth or tissue. In some embodiments, a sleeve 602 may include a body 615, a motor assembly sleeve section 617, a slot or opening 607, a finger positioning assembly 605 and/or a tab assembly 610. In some embodiments, the finger positioning assembly 605 may rise vertically from a surface of the sleeve body 615 and may form an arch-shaped opening into which a doctor's or user's finger may be placed. In some embodiments, a tab assembly 610 may be coupled, connected or attached to a side portion of a top part of the finger positioning assembly 605. In some embodiments, the tab assembly 610 may allow a user to pull on it to remove the finger positioning assembly 605 from the doctor's or user's finger.

In some embodiments, a gum or tissue numbing device sleeve 602 may include an opening or slot 607. In some embodiments, an opening or slot 607 may be positioned in a middle of a sleeve and run from approximately a front to a back to a sleeve 602. In some embodiments, the opening or slot 607 may run a length of the finger positioning assembly 605 and a tab assembly 610. In some embodiments, an opening or slot 607 may be large enough for a gum or tissue numbing device 620 to be slid into the opening or slot 607 and positioned inside or in the interior of the gum or tissue numbing device sleeve 602. In other words, the sleeve 602 may encompass or cover the gum or tissue numbing device 620. In some embodiments, an interior of the sleeve 602 may be hollow. In some embodiments, the motor assembly sleeve section 617 may be located on a bottom portion of a gum or tissue numbing sleeve 602. In some embodiments, the sleeve 602 may be one piece of material. In some embodiments, the sleeve 602 may be hollow although there may be protrusions for the on/off switch and/or a motor assembly sleeve section 617. In some embodiments, the sleeve 602 may be disposable. In some embodiments, the sleeve 602 may be two or more pieces of material connected or coupled together.

FIG. 6B illustrates a side view of a gum or tissue numbing device and a perspective view of the gum or tissue numbing device according to some embodiments. In some embodiments, the gum or tissue numbing device case may include a vibration motor assembly section 629, a case body 627 and/or an on/off switch contact section 630. In some embodiments, a case body 627 may include a first section 624 connected and/or coupled to the vibration motor assembly section 629 and/or the on/off switch contact section 630 and a second section 626 connected and/or coupled to the first section and/or the overmold or pad 625. In some embodiments, the on/off switch contact section 630 may include a copper finish or a metallic finish or material. In some embodiments, each of the gum or tissue numbing device may include this configuration.

FIG. 6D illustrates separate drawings of a gum or tissue numbing device 620 and a numbing device sleeve 602 and also illustrates a gum or tissue numbing device 620 being inserted into the slot or opening 607 of the numbing device sleeve 602. FIG. 6D illustrates power charging ports 645 in the gum or tissue numbing device 620. In some embodiments, the power charging ports 645 being located at an end of the gum or tissue numbing device 620. In some embodiments, the power charging ports 645 may provide power to a power source (e.g., a rechargeable battery) located in the gum or tissue numbing device 620.

FIG. 6C illustrates a gum or tissue numbing device and sleeve attached or coupled to a user or doctor's finger according to some embodiments. In some embodiments, in FIG. 6C, the gum or tissue numbing device 620 and sleeve 602 may be attached to a user's index finger 640. In some embodiments, the gum or tissue numbing device 620 and sleeve 602 may be positioned on a tip of a user's finger. Because the gum or tissue numbing device is being utilized, only the case is visible in FIG. 6C. Although the gum or tissue numbing device sleeve 602 is shown as being positioned or located on a doctor's or user's index finger, the gum or tissue numbing device 620 may be positioned or located on a doctor's or user's thumb 641 or alternatively on other fingers of the user or professional. As FIG. 6C illustrates, the index finger 640 may be positioned in the finger positioning assembly 605. In some embodiments, a portion of a tip (or a portion of a nail) of the index finger (or other finger) may be outside (e.g., not covered by) the finger positioning assembly 605. In some embodiments, a tip of the user's finger may be positioned vertically over the body 615 of the sleeve and the motor assembly cover 617 in order for the finger to control or press on the gum or tissue numbing device sleeve and the In some embodiments, the tab assembly 610 may be utilized by the medical professional or user to pull the gum or tissue numbing device and sleeve 602 onto the finger (or alternatively to pull off the gum or tissue numbing device 620 and sleeve 602 away from the finger). In some embodiments, the tab assembly 610 and the top of the finger positioning assembly 605 may be positioned on top of the medical professional's finger 640. In some embodiments, the bottom of a medical professional or user's finger rests on the pad 625 of the gum or tissue numbing device 620. In some embodiments, the medical professional may press the vibrating motor assembly sleeve section 617 against the patient's gum or tissue in order to numb the gum or tissue utilizing vibration. In some embodiments, the numbing device sleeve 602 may be one-size fit all to be able to fit index fingers or thumbs of various sizes.

FIG. 6E illustrates a bottom perspective exploded view of a single gum or tissue numbing device according to some embodiments. In some embodiments, the gum or tissue numbing device 620 may include a top or first cover assembly 626, a bottom or second cover assembly 624, a power source or battery 675, a vibrating motor assembly 670, an on/off switching assembly 680, one or more charging ports or a charging interface 685, and/or a battery charging and component power printed circuit board (PCB) 682. In some embodiments, the top or first cover assembly 626 may include a first recessed area for the power source/battery 675 and/or a second recessed area for the battery charging and component power PCB 682. In some embodiments, the top or first cover assembly 626 may have a hollow interior where a power source or battery 675 and/or the charging and power component PCB 682 may be positioned or located. In some embodiments, the top or first cover assembly 626 and a bottom or second cover assembly 624 may include openings at one end for the one or more charging ports or power interface 685. In some embodiments, the one or more charging ports or power interface 685 may be connected, attached or coupled to the charging and power component PCB 682. In some embodiments, the charging and power component PCB 682 may include rectifiers, regulators, amplifiers, capacitors, integrated circuits and/or other components that are utilized to transfer and provide power to the gum or tissue numbing device 620 and/or components therein. In some embodiments, a bottom or second cover assembly 624 may include a third recessed area for the vibrating motor assembly 670 and/or a fourth recessed area for the on-off switching assembly 680. In some embodiments, a bottom or second cover assembly 625 may have a hollow interior into which the vibrating motor assembly 670 and/or the on-off switching assembly 680 may be positioned or located.

FIG. 6F illustrates a combined sleeve and gum or tissue numbing device according to some additional embodiments. FIG. 6G illustrates a separated sleeve and gum or tissue numbing device according to the additional embodiments. The difference is that the sleeve has a different configuration and/or shape where the gum or tissue numbing device slips in an opening on a back or a rear part of the sleeve 652. In some embodiments, by having an opening 670 on a back or a rear part of the sleeve 652, it may be easier for the medical professional or doctor to place or insert the gum numbing device 620 into the sleeve. In this embodiment, the gum numbing device 620 is enclosed by the sleeve on a bottom portion of the sleeve 652, which is the portion of the sleeve 652 that is in contact with a patient's tissue or gum. In some embodiments, the gum numbing device 620 may be covered by the sleeve 652. In some embodiments, the sleeve 652 includes an arched or top portion 655, a sleeve body portion 660, and a sleeve bottom portion 665. In some embodiments, the arched or top portion 655 may be connected or coupled to a top part of both sides of the sleeve body portion 660 and may form an opening to allow a medical professional or user to place one of their fingers in the opening. In some embodiments, the arched or top portion 655 may be attached, connected or coupled to a tab portion 656. In some embodiments, the tab portion 656 may be attached to one side of a top part of the arched or top portion 655. In some embodiments, the tab portion 656 may allow for easier removal of sleeve 652 and the enclosed gum numbing device 620 from a medical professional or user's finger. In the embodiments illustrated in FIGS. 6F and 6G, the sleeve body portion 660 may be coupled, attached or connected to a sleeve bottom portion 665. In some embodiments, the sleeve body portion 660 may have a top surface that is flat. In some embodiments, a sleeve body portion 660 may have a front end and a back end and the front end or the back end may have an opening 670 into which the gum numbing device 620 is placed, inserted and/or positioned. In some embodiments, the sleeve bottom portion 665 may protrude from a bottom surface of the sleeve body portion 660. In some embodiments, the sleeve bottom portion 665 may be covering an area of a case of the gum numbing device 620 where the motor is located.

In some embodiments, dimensions of a sleeve or sleeve device 602 or 652 may be the following. In some embodiments, the sleeve 602 or 652 may have a height of 0.85 inches. In some embodiments, the sleeve or sleeve device 602 or 652 may have a height ranging from 0.6 inches to 1.1 inches. In some embodiments, the sleeve or sleeve device 602 or 652 may have a width of 0.6 inches. In some embodiments, the sleeve or sleeve device 602 or 652 may have a width of 0.35 inches to 0.85 inches. In some embodiments, sleeve 602 or sleeve 652 may have a length of 1.25 inches. In some embodiments, sleeve or sleeve device 602 or 652 may have a length ranging from 1 inch to 1.5 inches.

In some embodiments, dimensions of a tissue or gum numbing device 620 may be the following. In some embodiments, the tissue or gum numbing device 620 may have a height of 0.41 inches. In some embodiments, the tissue or gum numbing device 620 may have a height ranging from 0.25 to 0.6 inches. In some embodiments, the tissue or gum numbing device 620 may have a width of 0.55 inches. In some embodiments, the tissue or gum numbing device 620 may have a width ranging from 0.35 to 0.75 inches. In some embodiments, the tissue or gum numbing device 620 may have a length of 1.24 inches. In some embodiments, the tissue or gum numbing device 620 may have a length ranging from 1.04 inches to 1.45 inches.

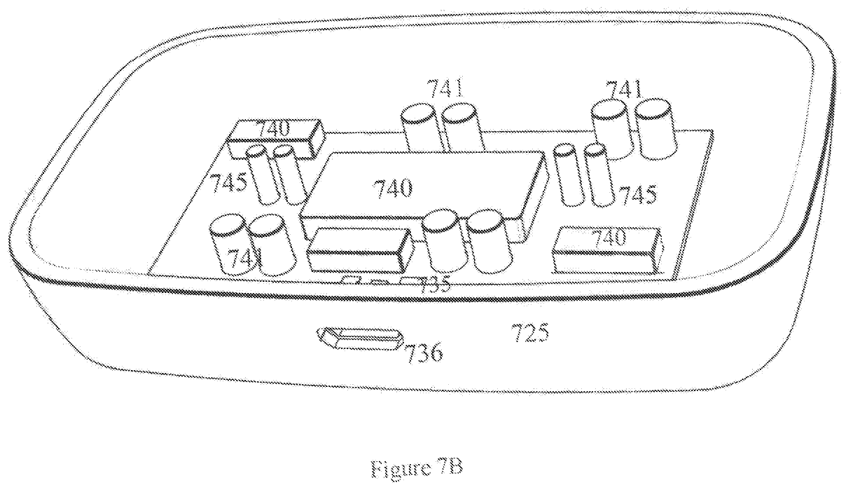

FIGS. 7A illustrates an exploded view of a gum or tissue numbing device power charging assembly for multiple gum or tissue numbing devices according to some embodiments. FIG. 7B illustrates a power charging assembly base according to some embodiments. In some embodiments, the gum or tissue numbing device power charging assembly 700 may provide convenient charging for one or more gum or tissue numbing devices 705 via a power connection such as a Universal Serial Bus (USB) or USB-C power interface. The numbing devices 705 may be placed or positioned in the numbing device power charging assembly 700 in order to provide power and/or charge to power sources (e.g., rechargeable batteries 675) in the gum or tissue numbing devices 705. In some embodiments, the sleeves are not on the gum or tissue numbing device 705 in the power charging assembly 700. In some embodiments, by the power charging assembly 700 have a cover or shield 710. In some embodiments, the cover or shield may protect the one or more gum or tissue numbing devices 620 from dirt or other contaminants in the environment as well as from bacteria or other harmful organisms. In some embodiments, the numbing device power charging assembly 700 may include a cover or shield 710, one or more gum or tissue numbing devices 705 (if the devices are installed and charging), a resting or positioning plate 715, a positioning or alignment band 720, a base or base assembly 725, a power electronics printed circuit board (PCB) and a plurality of electrical or mechanical components mounted or installed thereon 730, and/or a power interface or interface port 735. In some embodiments, an external power cable (not shown) may be plugged into the power interface or interface port 735 to receive power from an external source such as an AC power source (e.g., wall outlet) or a portable charger. This may provide power to charge the one or more gum or tissue numbing devices 705 that are resident or installed in numbing device power charging assembly 700. In some embodiments, the cover may be transparent and/or may also be made of a plastic material. In some embodiments, the cover 710 may rest or be installed onto the resting or positioning plate 715. In some embodiment, the positioning plate 715 may be made of a plastic material and may be white in color. In some embodiments, the resting or positioning plate may include one or more holes or openings 716 into which the gum or tissue numbing devices 705 may be inserted. In some embodiments, the holes or openings 716 may run from side to side in the positioning plate (as shown in FIG. 7A) while in other embodiments, the holes or openings may run from top to bottom of the resting or positioning plate 715. In some embodiments, the holes or openings 716 may pass through or be inserted through the resting or positioning plate 715 so that the gum or tissue numbing devices 705 may come in contact with charging pins or a charging interface in the base or base assembly 725. In some embodiments, a positioning or alignment band 720 may be inserted or located between the resting or positioning plate 715 and the base or base assembly 725 in order to provide proper positioning or alignment of the resting or positioning plate 715 with respect to the base assembly 725. In some embodiments, the positioning or alignment band 720 may run or be positioned around a bottom section of the resting or positioning plate 715 and/or a circumference of a bottom section of the resting or positioning plate. In some embodiments, the positioning or alignment band may be made of a metallic material. In some embodiments, the positioning or alignment band 720 may be made of a plastic material and may have a metallic finish.

In some embodiments, the base assembly or base 725 may encompass or include a power charging circuit printed circuit board 730. In some embodiments, the base assembly 725 may include an opening 736 through which a power interface port 735 may be exposed so that a power cable (not shown) may be inserted. In some embodiments, the base or base assembly 725 may have four sides which rise up from a bottom. In some embodiments, the base or base assembly 725 may be one piece in construction. In some embodiments, the four sides or walls of the base or base assembly 725 may form an opening or a hollow interior. In some embodiments, the power charging circuit PCB 730 may be positioned in a bottom of the base or base assembly 725. In some embodiments, the power charging circuit PCB 730 may be one or more sets of power charging pins or contacts 745. In some embodiments, the power charging ports or interface 685 of the gum or tissue numbing assembly 705 may fit, be poisoned on or inserted onto the charging pins or contacts 745 on the charging PCB 730 in order to provide power or charge the one or more gum or tissue numbing devices 705. In some embodiments, the charging PCB 730 may also include power storage components (e.g., capacitors) 741 and/or integrated circuit or electrical components 740, which can be utilized to regulate, store and or provide power to the charging pins or contacts 745 when an external power source is connected or coupled to the base or base assembly. In some embodiments, the charging PCB 730 may include one or more capacitors, resistors, amplifiers, diodes, regulators and/or other similar components.

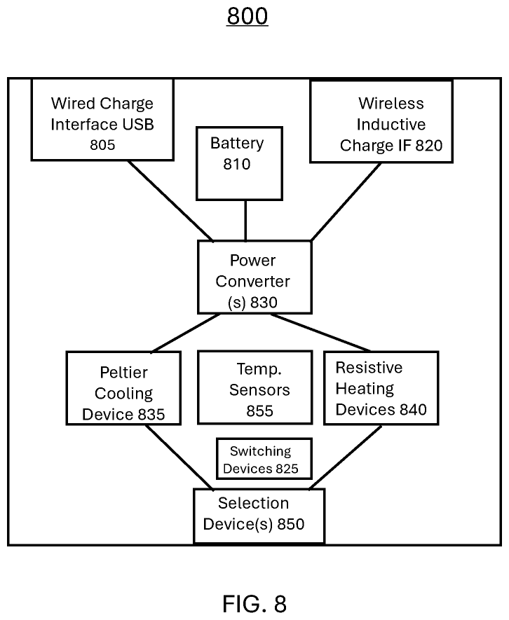

In exemplary embodiments, the gum numbing devices may be heated or cooled to provide additional comfort for the users. In some implementations, the gum numbing devices 200 (FIG. 2), 300 (FIG. 3), 500 (FIG. 5) or 620 (FIG. 6A or 6D) may be cooled or heated by putting in a refrigerator or freezer or an oven for a short period of time. However, that may be degrading to the electronics in the gum or tissue numbing devices. In other implementations, a portion of the gum numbing devices touching the tissue or gum of the user may be cooled or heated utilizing electrical power. Specifically, the molded soft rubber portion 120, 205 and 320 of the gum numbing devices 100, 200 and 300 of the sleeves 602 and 652 of the gum numbing devices 620 may be electrically heated or cooled. FIG. 8 is a block diagram of a heating and cooling system for the molded soft rubber portion or the sleeves of the gum numbing devices according to exemplary embodiments. In exemplary embodiments, the heating and cooling system 800 may a wired power interface (e.g., a USB interface such as USB or USB-C) 805, a wireless inductive power interface 820, a rechargeable battery 810, a electrical Peltier or cooling device 835, one or more electrical heating resistive elements 840, a power converter 830 and/or a switch or switching assembly 840. In exemplary embodiments, the molded soft rubber portions 120, 205 and 320 or the sleeves 602 and 652 of the gum numbing devices may be powered or receive power through a wired power interface 805 by a charging cable and an external power source. In alternative embodiments, the molded soft rubber portions 120, 205 and 320 or the sleeves 602 and 652 may be powered by a device having wireless charging circuity through inductive wireless coils 820 resident in the molded soft rubber portions 120, 205 and 320 or the sleeves 602 and 652 of the gum numbing devices. In a further embodiment, the molded soft rubber portions 120, 205 and 320 or the sleeves 602 and 652 may be powered by a rechargeable and removable battery 810 or by a non-removable battery with a long battery life. In some embodiments, these power sources 805, 810 or 820 may supply electrical power to one or more power converter devices 830. In exemplary embodiments, the one or more power converter devices 830 may convert the power to voltages that may be utilized by other components and specifically for the electrical cooling devices 835 and the electrical heating devices 840. In other words, the voltage and current supplied by the batteries or power sources may need to be converted into different voltage values (e.g., 5V, 3.3V, or 12 V). In exemplary embodiments, the molded soft rubber portions 120, 205 and 320 or the sleeves 602 and 652 may include Peltier devices or electrical cooling devices 835. In some implementations, the supplying of electrical power to an electrical cooling device 835 or Peltier device) may result in the electrical cooling device lowering a temperature on a surface connected or coupled to the electrical cooling device 835. In other words, a surface of the molded soft rubber portions 120, 205 and 320 or the sleeves 602 and 652 of the gum numbing devices may be lowered in temperature. This cooling provides additional comfort to some users and may be used to assist in numbing the patient's gum or tissue. In exemplary embodiments, the supplying of electrical power to an electrical heating device 840 such as resistive heating elements may result in the electrical heating device 840 generating heat and increasing a temperature of a surface connected or coupled to the electrical heating devices. In other words, a surface of the molded soft rubber portions 120, 205 and 320 or the sleeves 602 and 652 of the gum numbing devices may increase in temperature and this increase in temperature on the gum or tissue may also provide comfort to the patient. In exemplary embodiments, the heating or cooling may be activated by one or more buttons or selecting devices 850 on the molded soft rubber portions 120, 205 and 320 or the sleeves 602 and 652 of the gum numbing devices. One of the selection devices 850 may be used to activate the electrical cooling device 835 and another one of the selection devices may be used to activate the electrical heating device 840. In some implementations, the one or more selection devices 850 may utilize a switch or switching assembly 825 to toggle between the electrical cooling device and the electrical heating device. In exemplary embodiments, the heating and cooling system 800 for the molded soft rubber portions 120, 205 and 320 or the sleeves 602 and 652 of the gum numbing devices may also include one or more temperature sensors 855. In exemplary embodiments, the one or more temperature sensors 855 may measure temperature near the electrical heating device 840 and/or the electrical cooling device 835. If the temperature sensors record to high or low of a temperature reading, the one or more temperature sensors 855 may send a command or signal to the electrical heating device 840 and the electrical cooling device 835 to turn off because the temperature is too high or too low.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “controller,” “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. For example, one or more of the devices recited herein may receive image data of a sample to be transformed, transform the image data, output a result of the transformation to determine a 30 process, use the result of the transformation to perform the 3D process, and store the result of the transformation to produce an output image of the sample. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.”

The processor or controller as disclosed herein can be configured with instructions to perform any one or more steps of any method as disclosed herein.

As used herein, the term “or” is used inclusively to refer items in the alternative and in combination.

As used herein, characters such as numerals refer to like elements.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A power charging assembly, comprising:
two or more gum or tissue numbing devices, the two or more gum or tissue numbing devices including a power charging interface and one or more rechargeable batteries;
a base assembly;
one or more power electronics printed circuit boards (PCBs) to generate electrical power, the one or more power electronics PCBs including two or more charging interfaces, the two or more charging interfaces to connect to the associated power charging interface of the two or more gum or tissue numbing devices;
a power interface port, the power interface port configured to accept a power cable coupled to an external power source, the external power source to provide power to the power charging assembly through the power interface port.

2. The power charging assembly of claim 1, wherein the power charging interface is a USB or USB-C power interface.

3. The power charging assembly of claim 1, wherein the two or more gum or tissue numbing devices are positioned vertically in the assembly and connected to the one or more power electronics PCBs.

4. The power charging assembly of claim 1, further comprising a cover or shield, the cover or shield to protect the two or more gum numbing devices from dirt or bacteria or other contaminants.

5. The power charging assembly of claim 4, wherein the cover or shield rests on top edges of the base assembly.

6. The power charging assembly of claim 4, further comprising a positioning plate, the cover or shield resting on edges of the positioning plate.

7. The power charging assembly of claim 6, wherein the positioning plate has two openings, the two openings allowing the two or more gum or tissue numbing devices to pass through the positioning plate and connect to the one or more power electronics PCBs.

8. The power charging assembly of claim 6, further including a positioning band placed between the positioning plate and the base assembly.

9. The power charging assembly of claim 1, wherein the one or more power electronics printed circuit boards (PCBs) includes power storage capacitors, resistors, amplifiers, diodes and regulators configured to regulate store and provide power to the two or more charging interfaces in order to power the two or more gum or tissue numbing devices.
